(19) United States
(12) Patent Application Publication
(10) Pub. No.: US 2025/0268234 A1
(43) Pub. Date: Aug. 28, 2025

(54) Device For Biological Sample Collection From Organisms

(71) Applicant: Quanta Imaging, LLC, Gloucester, MA (US)

(72) Inventor: Robbie J Robertson, Gloucester, MA (US)

(73) Assignee: Quanta Imaging, LLC, Gloucester, MA (US)

(21) Appl. No.: 19/066,852

(22) Filed: Feb. 28, 2025

Related U.S. Application Data
(60) Provisional application No. 63/558,898, filed on Feb. 28, 2024.

(51) Int. Cl. A01K 15/04

(52) U.S. Cl. CPC A01K 15/04

(57) ABSTRACT

Disclosed herein are devices that permit easier handling of organisms such as mice during animal handling. The disclosed devices gain faster and greater control when handling, dosing, or manipulating a model organism as well as permitting gaining greater handling confidence in a shorter period than traditional methods. The disclosed devices further create less stress for both the research animal and the handler. The disclosed devices are portable and can be fixed into position using securing devices. The disclosed devices comprise a platform that allows for an organism to grasp the platform when placed on the platform. Furthermore, the devices are configured to be portable.

### FIELD

This disclosure relates generally to the field of biological research and particularly to collection of biological samples from organisms.

### BACKGROUND

Biological and biomedical research rely on the use of model organisms to produce data and identify new discoveries. Organisms such as mice are of particular importance and proper handling of these organisms improves their utility as model organisms for research in biopharmaceuticals and biology.

One such technique for obtaining tissues and other biological samples from organisms. The most common technique for handling model organisms such as mice is to place a mouse on top of a cage such that the mouse will instinctually grasp the top of the cage. Many experiments require organisms and require proper handling of the organism. Proper animal handling improves experimental outcomes as well.

However, utilizing the top of a cage can be difficult and lead to mistakes on the part of the researcher. These errors can lead to damage to tissues and undue stress on the organism such that samples are affected. In addition, this technique requires movement of the mouse to another area for isolating tissues and other samples.

As disclosed herein, the inventors have designed a device to allow easy handling of organisms such as mice and more rapid, lower stress handling of organisms by a researchers having a range of expertise. The disclosed devices gain faster and greater control when handling, dosing, or manipulating a model organism as well as permitting gaining greater handling confidence in a shorter period than traditional methods. The disclosed devices further create less stress for both the research animal and the handler. Additionally, the portable nature of the device permits researchers to work in safe working zones such as hoods. The device further permits the easy storage of other devices necessary to isolate samples.

### SUMMARY

Disclosed herein are devices that permit the handling of living organisms such as mice and/or biological sample collection. The disclosed devices increase the control that researchers have over the organism and decrease the time necessary to handle the organism. The design of the disclosed devices are an improvement on present techniques that utilize grating on biological safety cabinets or cages. The devices disclosed herein permit a researcher to perform all activities in a single station and to allow simple manipulation of the organism. The disclosed devices therefore increase the efficiency of experiments by minimizing handling errors and reducing animal stress, even by novice animal handlers, thereby ensuring the safety of researchers and organisms.

Aspects of the devices include a flat platform that comprises an area that defines a series of holes and a stand, wherein the stand permits the device to be positioned and secured. In some embodiments, the stand is secured in place. In particular embodiments, the stand comprises suction cups to secure the device in place. In certain embodiments, the device is portable.

In other embodiments, the device comprises a tray for the collection of fluids. In still other embodiments, the area defines holes that permit the storage of other devices necessary for isolating samples. The area can further be designed to approximate a screen, which permits fluids to drain through the platform into the tray.

In particular embodiments, the device comprises a material selected from the group consisting of thermoplastic, polycarbonate, polypropylene, acetal copolymer, PVC, high-density polyethylene, aluminum, steel, polyvinyl, and combinations thereof. In more particular embodiments, the device comprises materials that can be easily cleaned and sterilized.

In other embodiments, the device permits attachment of tubing and other fluid isolation equipment to the platform.

### BRIEF DESCRIPTION OF THE FIGURES

The following disclosure provides a description of the figures, which show various embodiments of the disclosed devices and should not be considered limiting, such figures being:

FIG. 1 is a pictorial representation showing an embodiment of the device with a mouse on the platform;

FIG. 2 is a drawing that shows an embodiment of the device including exemplary dimensions;

FIG. 3 is a pictorial representation showing an embodiment of the device with lab equipment placed on the device.

### DETAILED DESCRIPTION

Disclosed herein are devices that permit easier handling of organisms such as mice during experimental procedures in biotechnology and pharmaceuticals. The disclosed devices utilize the natural instinct of organisms like rodents when a pulling motion occurs on the tail of an organism. When pulling back slightly on the tail, there is a natural tendency of the organism that allows for the body to be extended, thereby helping to stabilize the animal during the gripping movement, and the organism's attention is on the pulling that's occurring and not on the researcher. The pulling distracts the organism for a few seconds allowing the user to get an appropriate grip on the animal without hurting it and while minimizing stress. Accordingly, the disclosed devices provide support to allow researchers to handle organisms without harming the organism.

Handling an organism requires control in order to safely work with it in a research setting. Safe handling prevents injury to both workers and to the animals who they work with. Common practice in the biotech/pharma industry has been to use the grating on the biological safety cabinet to stabilize rodents. This can take the organism outside of a safe working zone such as a hood. In addition, present practices require use of liquid-soaked paper towels or preexisting metal bars on the top of cages.

The disclosed devices provide better grasping surface on the platform. The disclosed devices are also portable and can be fixed into position using securing devices. This permits the disclosed devices to be positioned in safe working zones in the lab. The disclosed devices comprise a platform that allows for an organism to grasp the platform when placed on the platform. The disclosed devices further comprise a one or more securing stands attached to the platform that allow the device to be secured to another surface upon which the platform is placed. The disclosed devices permit laboratory equipment to be placed in easy reach of the researcher.

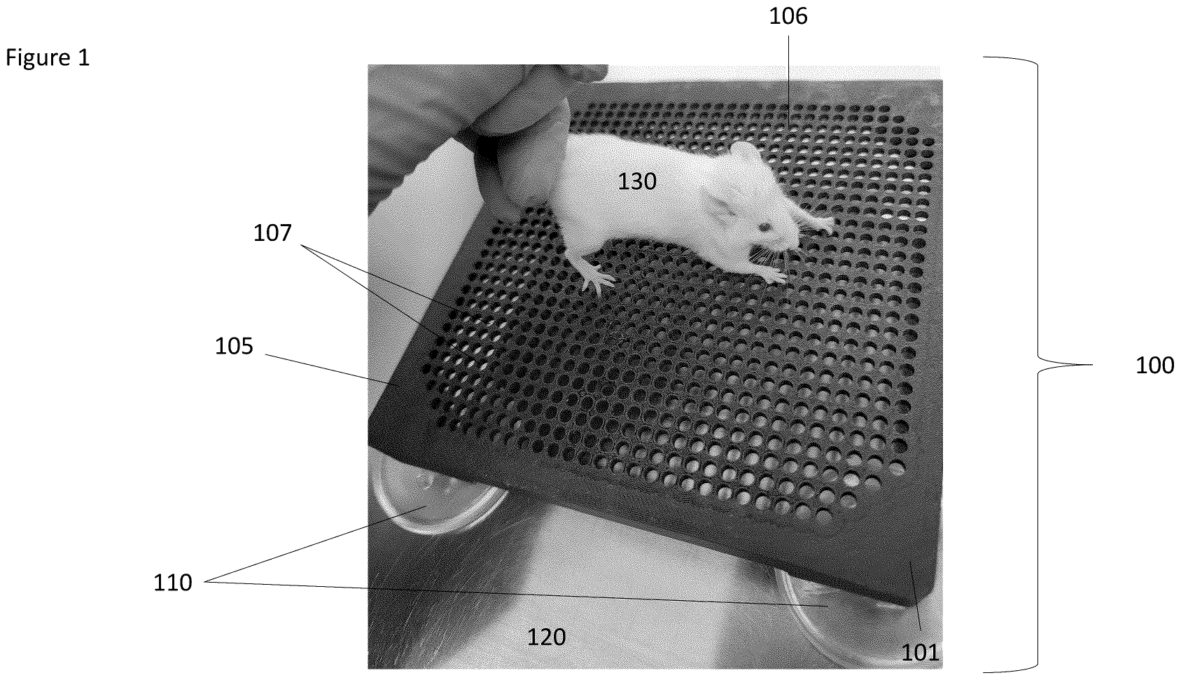

As shown in FIG. 1, the device 100 comprises a platform 105 and multiple securing stands 110. The platform 105 comprises an area 106 that defines a series of holes 107. The platform 105 allows for greater control when handling, dosing, or manipulating model organisms. The holes 107 are useful to permit an organism such as a mouse 130 to grip the platform 105. The holes 107 permit multiple gripping points for the organism and allows a stable platform for experiments to go smoothly. The holes 107 can be arranged such that the area 106 has the appearance of a screen. The holes 107 should be large enough to permit the organism to grip the holes 107.

Due to the multiple points where the organism can grip and the stable platform design, the disclosed devices render even novice animal handlers more confident and capable. The design of the device also permits more rapid handling of organisms due to the area 106 and platform 105. This decreases the stress that the organism endures and improves experimental outcomes. Furthermore, it reduces the stress of the researcher and decreases the amount of time needed to isolate samples and handling of the organism.

The platform 105 can be comprised of thermoplastic, polycarbonate, polypropylene, acetal copolymer, PVC, high-density polyethylene, polyvinyl, metal such as aluminum and steel, polyvinyl, and combinations thereof. The platform 105 can also be designed for sterilization procedures. Furthermore, the platform 105 can be coated with a material to prevent adherence of materials to the platform 105. In certain embodiments, the material is hyaluronic acid, heparin, Teflon, and poly-N-vinylpyrrolidone. In certain embodiments, the platform is coated with a material to cause the platform to have a charged surface. In some embodiments, the charge is a positive charge. In other embodiments, the charge is a negative charge. Examples of such coatings that cause a charged surface are silane, poly-lysine, keratin, mint oil, chitosan, and titanium oxide.

As shown in FIG. 1, the device 100 further comprises a plurality of securing stands 110. In this embodiment, the securing stands 110 are suction cups. The function of the securing stands is to interact with a surface 120 and ensure that the device 100 does not move or slip. In some embodiments, the securing stands 110 allow the device 100 to be bolted to a surface. In other embodiments, the securing stands 110 can be clips that attach to the edge of a surface. In the embodiment shown in FIG. 1, the device 100 comprises at least two securing stands 110. In other embodiments, the device 100 comprises a securing stand 110 located at every corner 101 of the device 100.

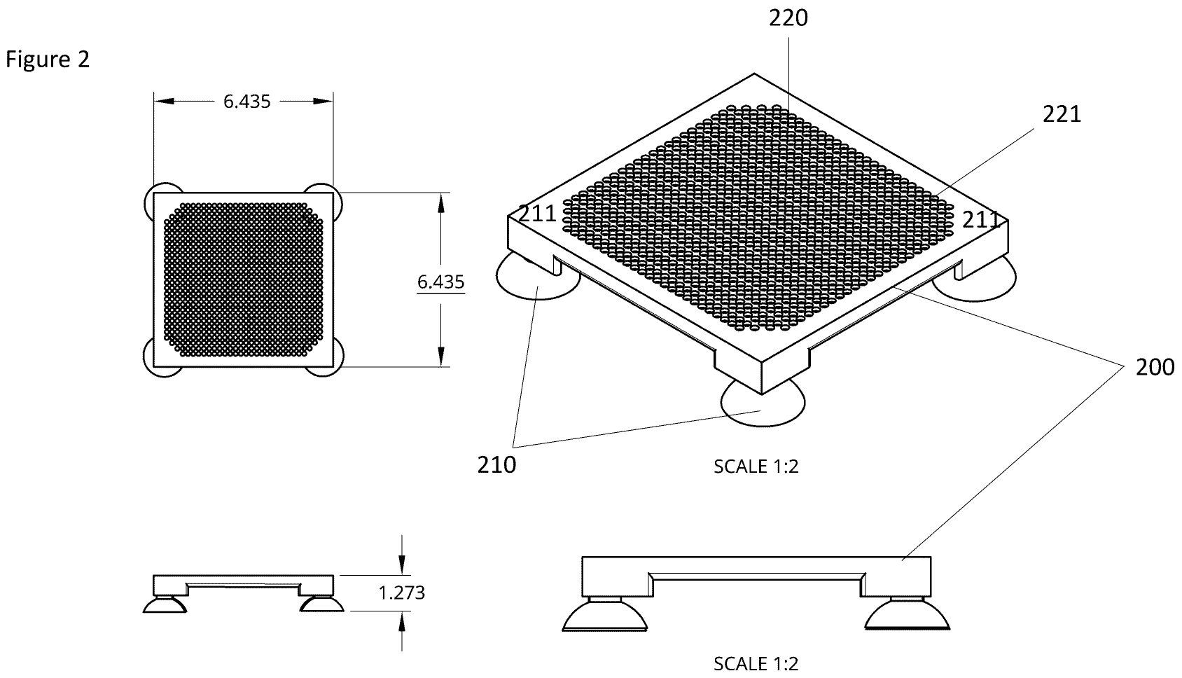

FIG. 2 shows the exemplary dimensions of an embodiment of the device 200. In this embodiment, the device 200 is a square that is 6.435 inches by 6.435 inches. The device 200 also stands 1.273 inches tall, including the securing stands 210. As shown in FIG. 2, the device 200 comprises securing stands 210 at each corner 211 and the securing stands 210 are suction cups. In addition, FIG. 2 shows an area 220 that defines a series of holes 221 such that the area 220 looks like a screen.

It should be noted that the device can be a range of sizes, shapes, and heights. Any range of sizes, shapes, and heights are acceptable so long as the device permits handling of organisms and extraction of samples.

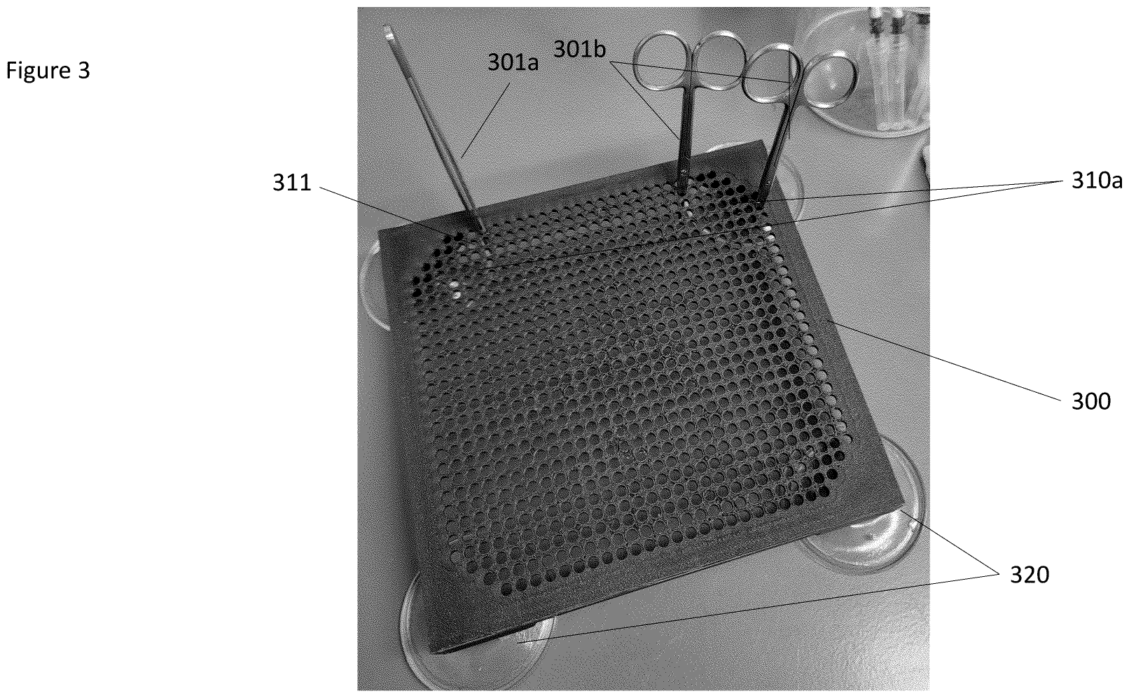

In some embodiments, the device 300 is configured to hold laboratory equipment 301a and 301b used in sample collection from model organisms (FIG. 3). As shown in FIG. 3, the device 300 holds tweezers 301a and surgical scissors 301b. In particular embodiments, the area 310 of the device 300 comprises a portion 310a configured to hold laboratory equipment such as tweezers, surgical scissors, tubing, clips, and other laboratory equipment useful in sample collection. In some embodiments, the portion 310a defines holes 311 that can hold said laboratory equipment 301a and 301b. This particular embodiment shows securing stands 320 shown at each corner of the device 300. In other embodiments, the device 300 comprises an extension from the platform that holds laboratory equipment (not shown). In such embodiments, the extension is a rack that permits the equipment to be inserted and held.

Particular disclosed devices are configured to allow a tray to be inserted beneath the platform to allow collection of fluids. In some embodiments, the device comprises tabs that permit a tray to be inserted into place under the platform.

In certain embodiments, the device comprises a connector that permits tubing to be held in place (not shown). The connector is configured to allow suction tubing to be held that permits the removal of fluids and samples using suction devices.

What is claimed:

1. A device for handling model organisms during research, the device comprising a platform and one or more securing stands, wherein the platform further comprises an area that defines a plurality of holes, wherein the holes are configured to permit an organism to grasp the platform and to permit fluids to fall through the platform.

2. The device of claim 1, wherein the platform comprises polycarbonate, polypropylene, acetal copolymer, PVC, high-density polyethylene, polyvinyl, metal such as aluminum and steel, polyvinyl, and combinations thereof.

3. The device of claim 1, wherein the device comprises four securing stands.

4. The device of claim 3, wherein the securing stands are positioned at each corner of the platform.

5. The device of claim 3, wherein the securing stands are suction cups.

6. The device of claim 1, wherein the device comprises a portion configured to hold laboratory equipment.

7. The device of claim 1, wherein the plurality of holes are aligned in rows to permit the organism to grasp in multiple directions.

8. The device of claim 1, wherein the platform is coated with a material selected from the group consisting of hyaluronic acid, heparin, Teflon, and poly-N-vinylpyrrolidone.

9. The device of claim 1, wherein the platform further comprises a coating that provides the platform with a charged surface.

10. The device of claim 9, wherein the coating is selected from the group consisting of silane, poly-lysine, keratin, mint oil, chitosan, and titanium oxide.
